(19) United States
(12) Patent Application Publication
(10) Pub. No.: US 2009/0031005 A1
(43) Pub. Date: Jan. 29, 2009

(54) Portal COM Module

(75) Inventors: Ryan Patrick Swanson, Atlanta, GA (US); Jay Oliver Glasglow, Acworth, GA (US)

Correspondence Address: AT&T Legal Department;Attn: Patent Docketing, One AT&T Way, Room 2A-207, Bedminster, NJ, 07921, US

(73) Assignee: BELLSOUTH INTELLECTUAL PROPERTY CORPORATION, Wilmington, DE (US)

(21) Appl. No.: 11/781,584

(22) Filed: Jul. 23, 2007

(51) Int. Cl. G06F 15/16

(52) U.S. Cl. 709/218

(57) ABSTRACT

Included are embodiments for providing data. At least one embodiment of a method includes receiving a request at a web browser configured to send data via a first socket and sending the request to a COM module that is configured to send data via a second socket, the second socket being different than the first socket. Similarly, some embodiments include receiving at least a portion of requested data via the second socket, such that a continuous connection is established via the second socket and providing for display, at the web browser, at least a portion of the received data.

### TECHNICAL FIELD

This disclosure relates to computer communications. More specifically, this disclosure relates to a portal COM module that may be configured for providing data to an Internet user.

### BACKGROUND

Many Internet users utilize web browsers for searching the Internet. Web browsers generally provide users with the ability to view static information. More specifically, to view a web page, a web browser sends a first request to a web server associated with the web page. The web server may send the requested information to the web browser. If the user wishes to update the information, the user can select a refresh option. The refresh option may send a second request to the web server. Generally speaking, between the first request and second request, the web browser may have no connection with the web server.

Additionally, many web browsers are designed such that access to the Internet may be constrained to a limited number of sockets. While this limitation may have little effect when requesting static data, this limitation has generally created problems when web designers wish to provide users with dynamic data that is continuously refreshed. Oftentimes, dynamic data utilizes one or more of the sockets utilized by the web browser. As the sockets provided to the web browser may be limited, the amount of dynamic data provided to a web browser may also be limited.

Thus, a heretofore unaddressed need exists in the industry to address the aforementioned deficiencies and inadequacies.

### SUMMARY

Included are embodiments for providing data. At least one embodiment of a method includes receiving a request at a web browser configured to send data via a first socket and sending the request to a COM module, the COM module being configured to send data via a second socket, that is different than the first socket. Similarly, some embodiments include receiving at least a portion of requested data via the second socket, such that a continuous connection is established via the second socket and providing for display, at the web browser, at least a portion of the received data.

Additionally included are embodiments of a user device for providing data. At least one embodiment of a user device includes a first receiving component configured to receive a request at a web browser configured to receive data via a first socket and a COM module component configured to send data via a second socket that is different than the first socket. Similarly, some embodiments include a sending component configured to send the received request to the COM module logic and a second receiving component configured to receive at least a portion of requested data via the second socket, such that a continuous connection is established via the second socket. Still some embodiments include a providing component configured to provide, for display at the web browser, at least a portion of the received data.

Other systems, methods, features, and advantages of this disclosure will be or become apparent to one with skill in the art upon examination of the following drawings and detailed description. It is intended that all such additional systems, methods, features, and advantages be included within this description, be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

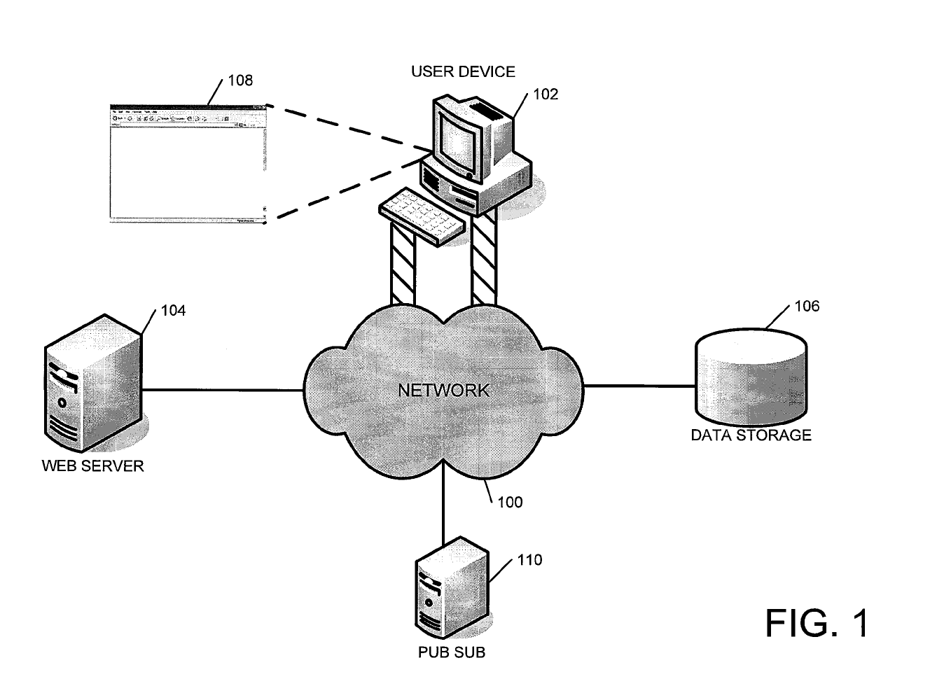

FIG. 1 is a network diagram illustrating an exemplary embodiment of components that may be utilized in accessing a web page.

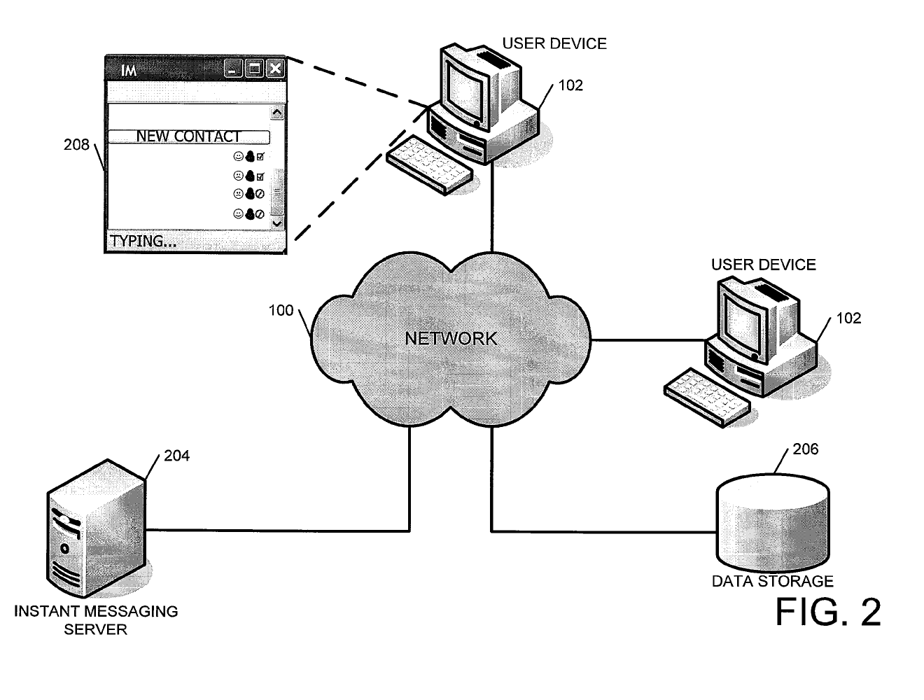

FIG. 2 is a network diagram illustrating an exemplary embodiment of components that may be utilized in an instant messaging (IM) session, similar to the diagram from FIG. 1.

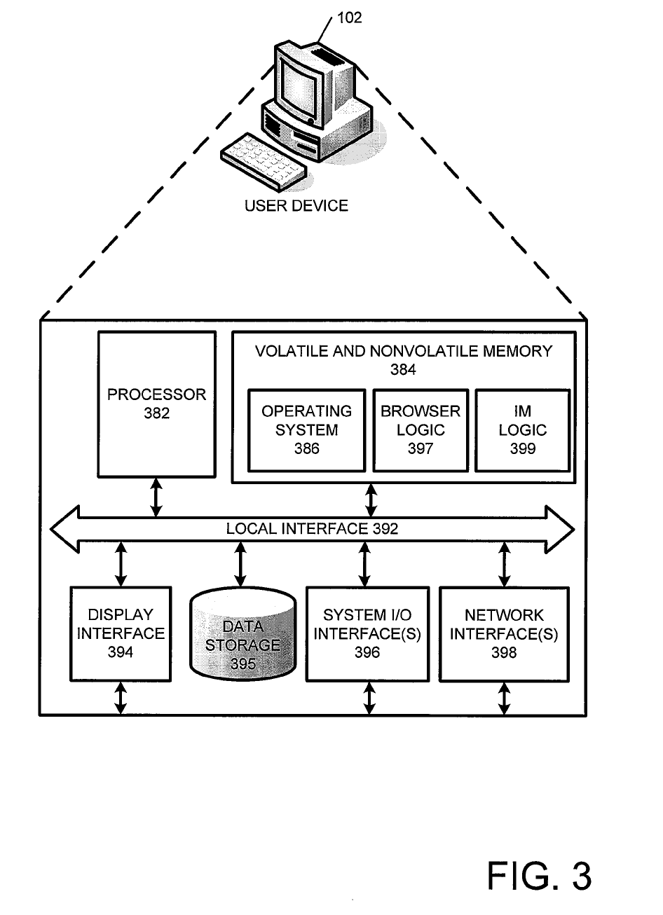

FIG. 3 is a diagram illustrating components that may be utilized in a user device, such as the user device from FIGS. 1 and 2.

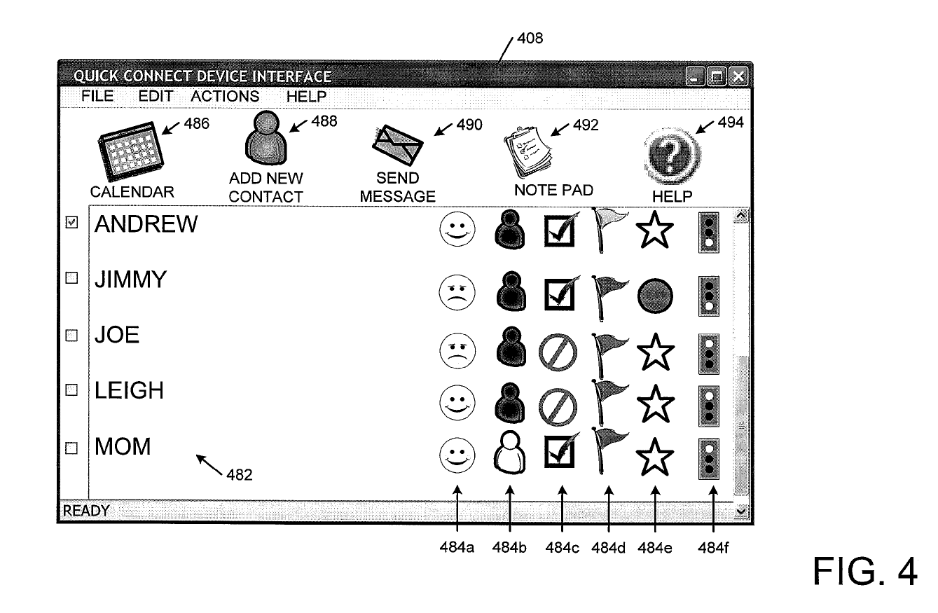

FIG. 4 is a diagram illustrating an exemplary embodiment of a quick connect interface, which may be utilized by a user device, such as the user device from FIG. 1.

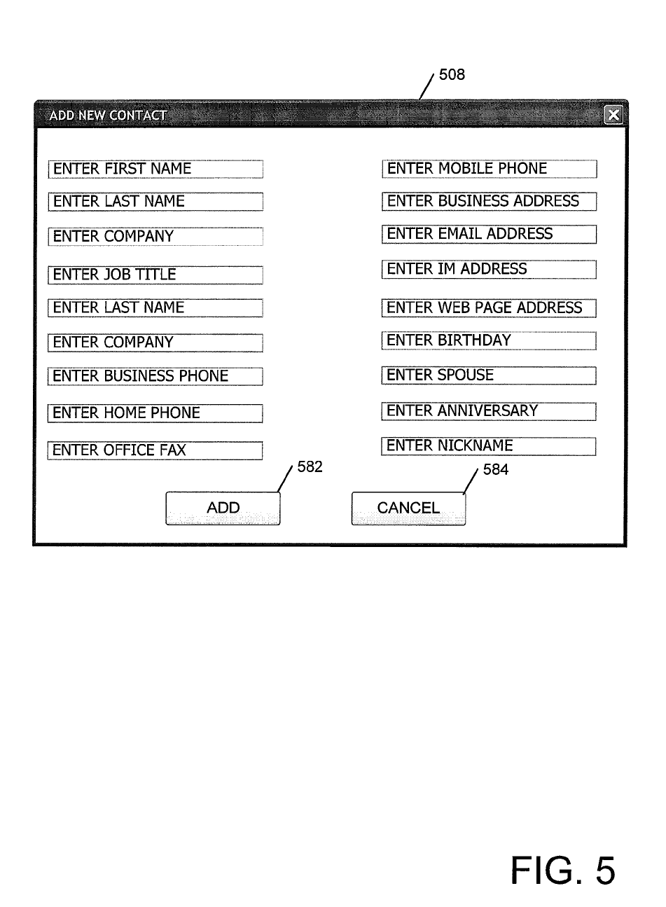

FIG. 5 is a diagram illustrating an exemplary embodiment of an add new contact interface, which may be displayed, in response to selection of the add new contact option from FIG. 4.

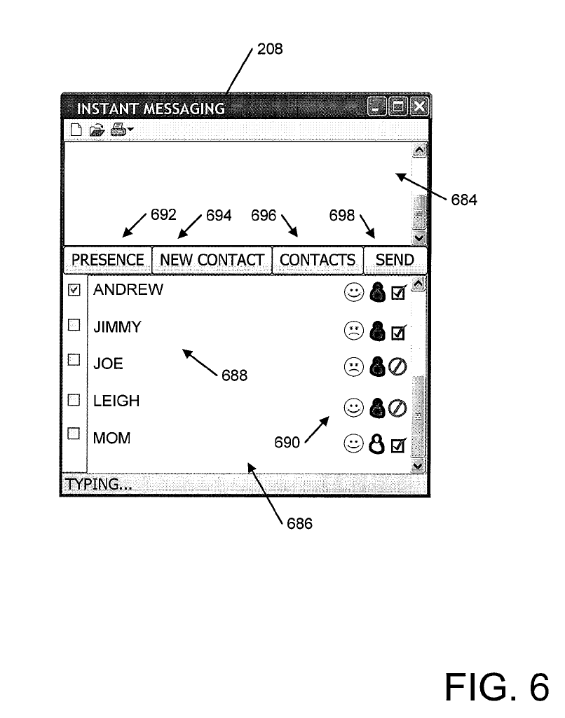

FIG. 6 is a diagram illustrating an exemplary embodiment of an instant messaging interface that may be configured for facilitating an instant messaging session, similar to the interface illustrated in FIG. 2.

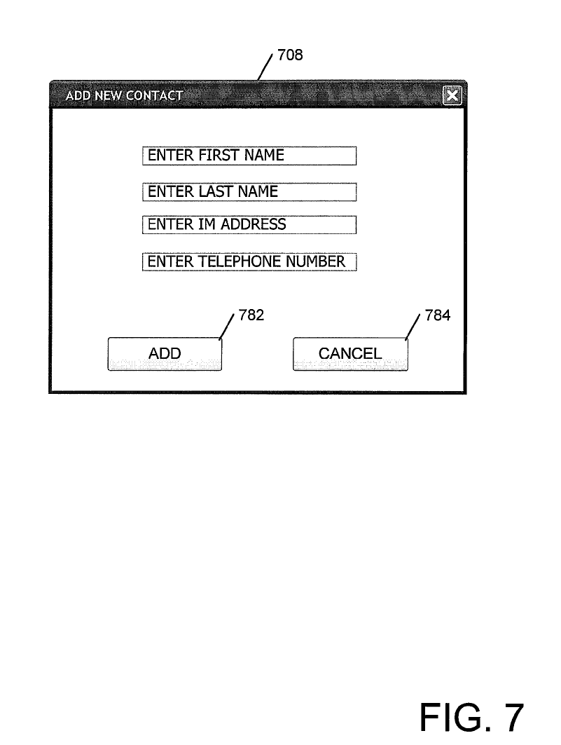

FIG. 7 is a diagram illustrating an exemplary embodiment of an add new contact interface, which may be accessed in response to selection of the add new contact option from FIG. 6.

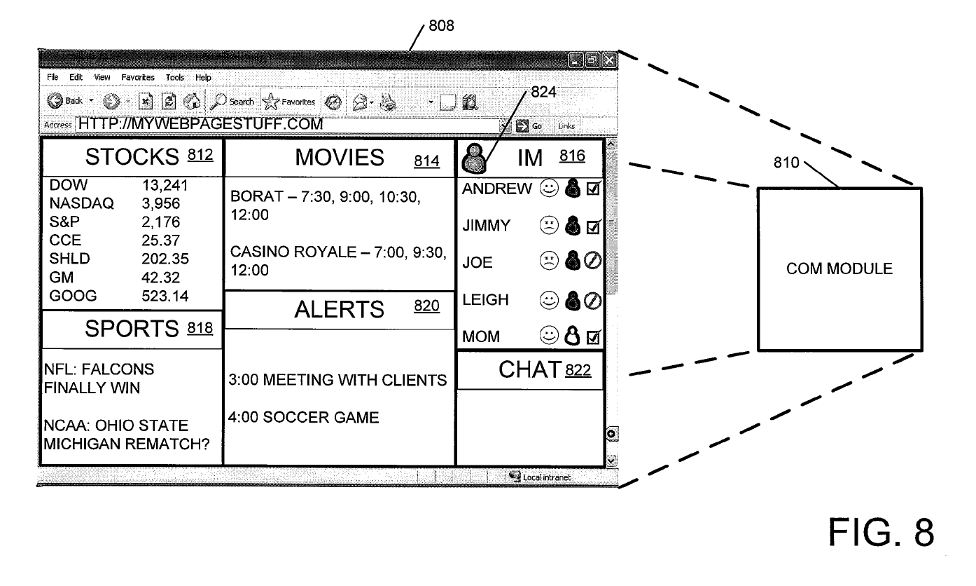

FIG. 8 is diagram illustrating an exemplary embodiment of a web browser interface that utilizes a COM module in a network configuration, similar to the network configuration from FIGS. 1 and 2.

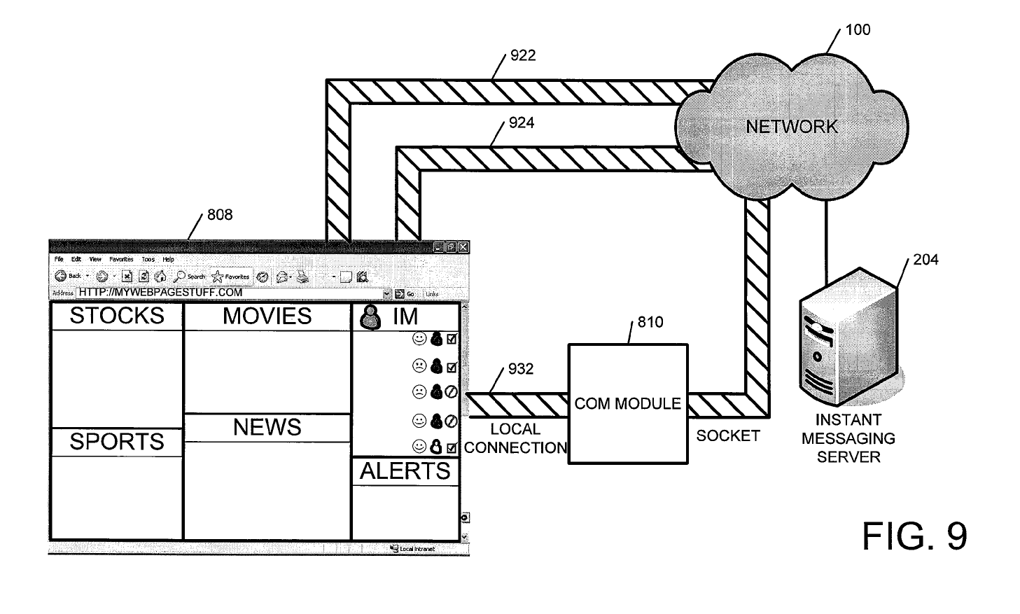

FIG. 9 is a diagram illustrating an exemplary embodiment of a web browser interface and COM module in a network configuration, similar to the diagram from FIG. 8.

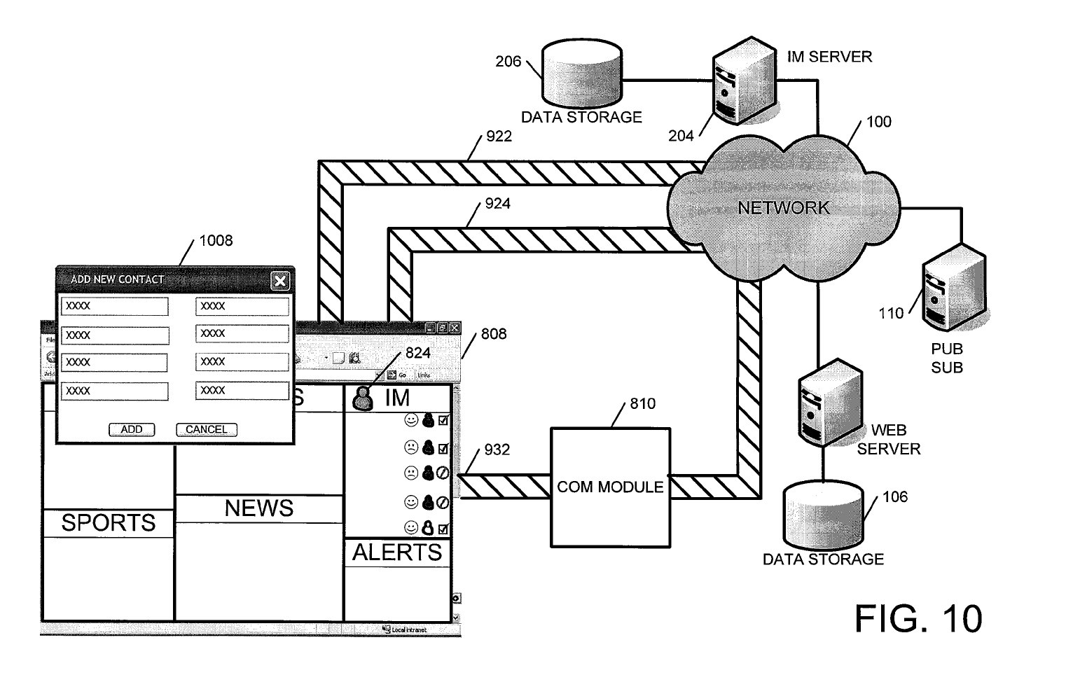

FIG. 10 is a diagram illustrating an exemplary embodiment of a web browser interface and an add new contact interface in a network configuration, similar to the diagram from FIG. 9.

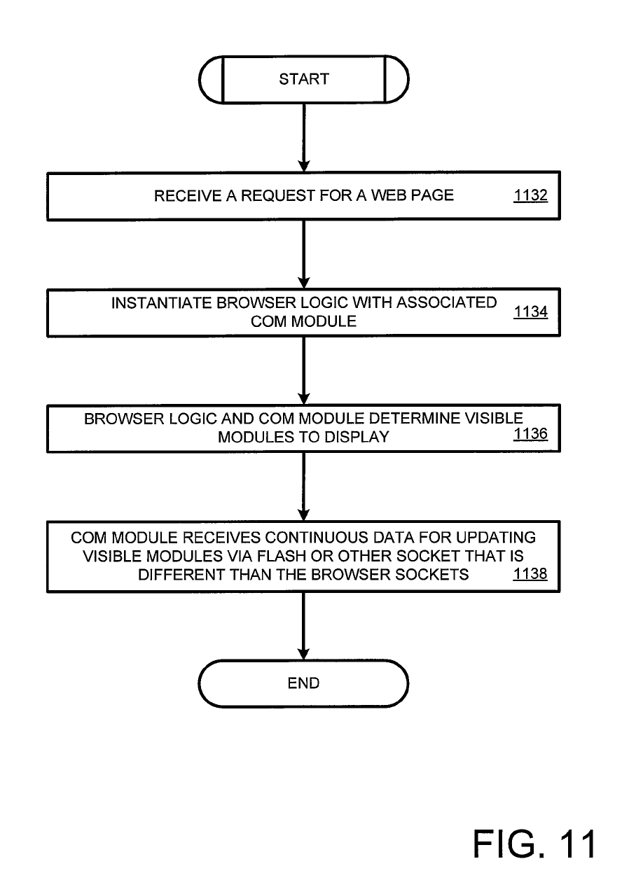

FIG. 11 is a flowchart illustrating an exemplary embodiment of a process for utilizing a socket that is different than the socket allocated for a web browser, such as the web browser from FIG. 1.

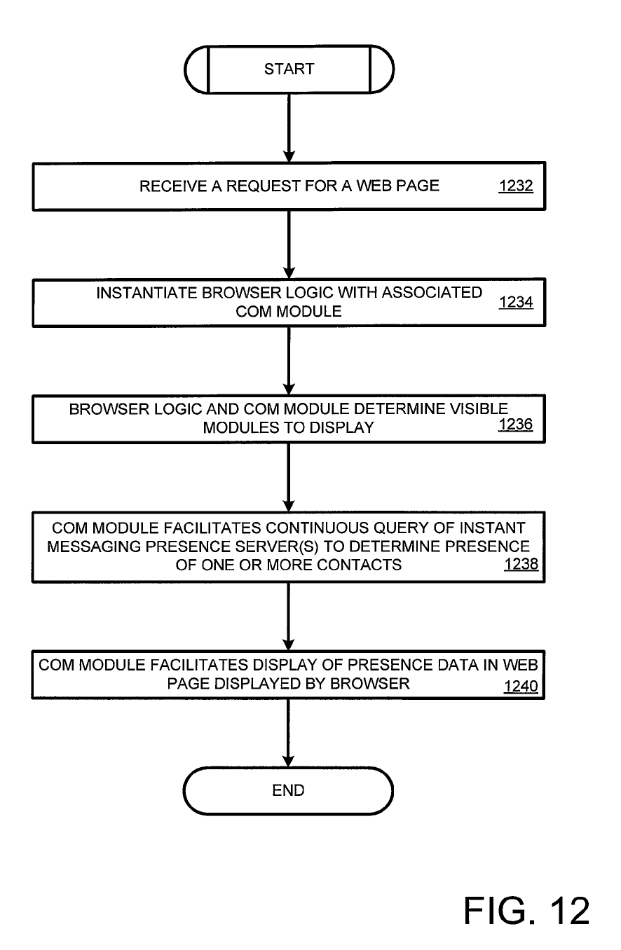

FIG. 12 is a flowchart illustrating an exemplary embodiment of a process for facilitating display of presence data in a web page displayed by a web browser, similar to the flowchart from FIG. 11.

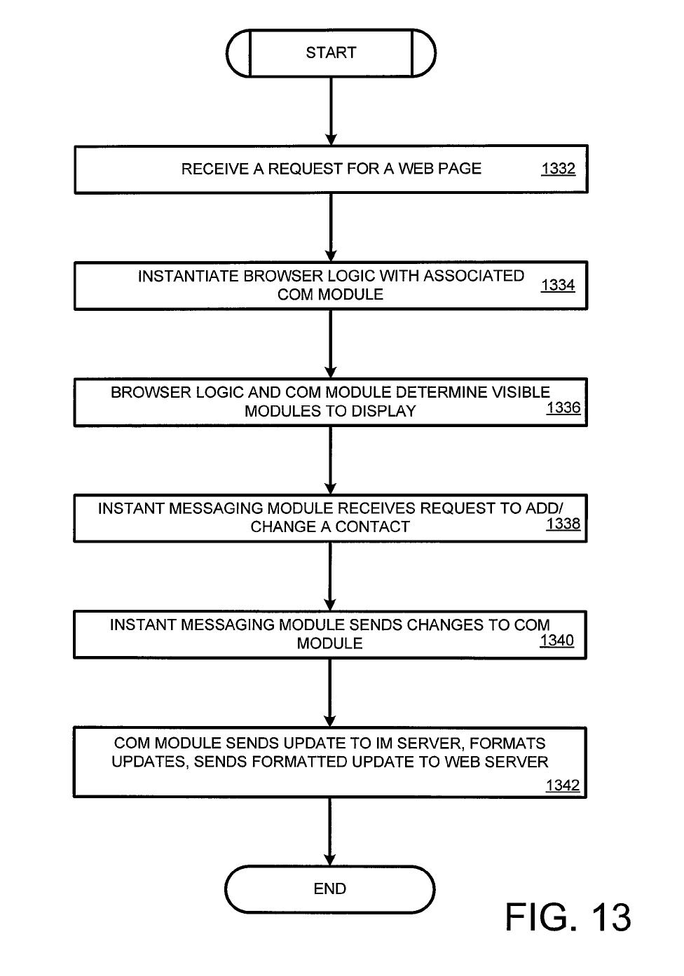

FIG. 13 is a flowchart illustrating an exemplary embodiment of a process that may be utilized for updating a quick connect server, similar to the flowchart from FIG. 12.

### DETAILED DESCRIPTION

FIG. 1 is a network diagram illustrating an exemplary embodiment of components that may be utilized in accessing a web page. As illustrated in the nonlimiting example of FIG. 1, a user device 102 can communicate with a web server 104 via a network 100, such as the Internet, a Wide Area Network (WAN), a Local Area Network (LAN), and/or another network. More specifically, a user can access a web browser associated with the user device 102, which may be configured to send a web page request to the web server 104. The web server 104 may access data (locally and/or from a data storage 106) to send to the user device 102. The user device 102 may be configured to receive the data from the web server 104 to render a web browser display 108. The web browser display 108 may be configured to present at least a portion of the data received from the web server 104. Depending on the particular configuration, the web browser logic (discussed in more detail below) may be configured to limit the number of sockets that the user device 102 may utilize when navigating the Internet. More specifically, in at least one nonlimiting example, a web browser may restrict the number of available sockets to prevent over consumption of bandwidth and inefficient use of resources. While this limitation may generally not affect normal web browsing, if a user desires to view dynamic data and/or establish a continuous Internet connection, the socket limitation may affect the web browsing experience.

One should note that while a web browser display is illustrated in FIG. 1, this is a nonlimiting example. More specifically, other local applications that are configured to facilitate access to the Internet may use the same sockets and/or be limited as the web browser displayed in FIG. 1. Additionally, while a Personal Computer (PC) is displayed as the user device 102, this is also a nonlimiting example. More specifically, any device that utilizes a web browser where sockets to the Internet are limited may be included. Such devices can include, but are not limited to, a cellular telephone, Personal Digital Assistant (PDA), Kitchen Broadband Device (KBD), Quick Connect device, and/or other wired and wireless devices.

Also coupled to the network 100 is a Publish-Subscribe (Pub-Sub) network 110. The Pub-Sub network 110 may include one or more servers, data storage, etc. to provide messages and/or updates to subscribers. As a nonlimiting example, if a user subscribes to a sports Pub-Sub service, the Pub-Sub network 110 may be configured to repeatedly and/or continuously send updates to one or more sports scores, news, and/or other sports data. Depending on the particular configuration, the Pub-Sub network 110 may operate on an Extensible Markup Language (XML) platform, independent of Hyper Text Markup Language (HTML) associated with a web page and/or ports associated with web browser logic 397, illustrated in FIG. 3.

FIG. 2 is a network diagram illustrating an exemplary embodiment of components that may be utilized in an instant messaging (IM) session, similar to the diagram from FIG. 1. More specifically, as illustrated in the nonlimiting example of FIG. 2, a user on the user device 102 may establish an instant messaging (IM) session with an IM server 204 via the network 100. The IM session may be facilitated by the IM logic 399 (FIG. 3) on the user device 102 (discussed in more detail below). When a connection between the user device 102 and the IM server 204 is established, the IM server 204 can determine user settings, contacts, appointments, etc., which may be stored locally on the IM server 204 and/or remotely on a data storage component 206. Similarly, a user on the user device 102 may establish an IM session with the IM server 204.

In operation, a user on the user device 102 may instantiate the IM logic 399 to begin an IM session. The IM logic 399 may launch an IM display 208, which may facilitate establishment of the IM session and additionally provide preferences, contacts, addresses, etc. to the user, once the IM session is established. Additionally, once the user has established an IM session, the user may enter into an IM communications session with a user on the user device 102, which may have also established an IM session with the IM server 204 (and/or a different IM server).

One should note that, in at least one embodiment, an established IM session may include a continuous connection with the Internet. However, unlike the limited portal configuration from FIG. 1, the IM logic 399 may not be limited to the same sockets as the web browser logic 397. As such, a user may establish a dedicated IM session without affecting normal Internet browsing.

One should also note that while the IM server 204 may operate in a proprietary protocol, this is not a requirement. More specifically, the IM server 204 may be configured to operate in any of a plurality of IM protocols. Additionally, the IM server 204 may operate using a Jabber or similar protocol utilizing Extensible Messaging Presence Protocol (XMPP), Extensible Markup Language (XML), and/or other protocols.

FIG. 3 is a diagram illustrating components that may be utilized in a user device, such as the user device 102 from FIGS. 1 and 2. Although a wire-line user device is illustrated, this discussion can be applied to wireless devices, as well. According to exemplary embodiments, in terms of hardware architecture, as shown in FIG. 3, the user device 102 includes a processor 382, volatile and nonvolatile memory 384, a display interface 394, data storage 395, one or more input and/or output (I/O) device interface(s) 396, and/or one or more network interfaces 398 that are communicatively coupled via a local interface 392. The local interface 392 can include, for example but not limited to, one or more buses and/or other wired or wireless connections. The local interface 392 may have additional elements, which are omitted for simplicity, such as controllers, buffers (caches), drivers, repeaters, and receivers to enable communications. Further, the local interface 392 may include address, control, and/or data connections to enable appropriate communications among the aforementioned components. The processor 382 may be a device for executing software, particularly software stored in volatile and nonvolatile memory 384. The processor 382 can include any custom made or commercially available processor, a central processing unit (CPU), an auxiliary processor among several processors associated with the user device 102, a semiconductor based microprocessor (in the form of a microchip or chip set), a macroprocessor, and/or generally any device for executing software instructions.

The volatile and nonvolatile memory 384 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 384 may incorporate electronic, magnetic, optical, and/or other types of storage media. One should note that the memory 384 can have a distributed architecture (where various components are situated remote from one another), but can be accessed by the processor 382.

The software in the memory 384 may include one or more separate programs, which may include an ordered listing of executable instructions for implementing logical functions. In the example of FIG. 3, the software in the volatile and nonvolatile memory 384 may include the web browser logic 397 and/or IM logic 399, as well as an operating system 386. The operating system 386 may be configured to control the execution of other computer programs and provides scheduling, input-output control, file and data management, memory management, and communication control and related services.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the volatile and nonvolatile memory 384, so as to operate properly in connection with the operating system 386.

The Input/Output devices that may be coupled to the system I/O Interface(s) 396 may include input devices, for example but not limited to, a keyboard, mouse, scanner, touch screen, microphone, etc. Further, the Input/Output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

Additionally included are one or more of the network interfaces 398 for facilitating communication with one or more other devices. More specifically, network interface 398 may include any component configured to facilitate a connection with another device. While in some embodiments, among others, the user device 102 can include the network interface 398 that includes a Personal Computer Memory Card International Association (PCMCIA) card (also abbreviated as “PC card”) for receiving a wireless network card, this is a nonlimiting example. Other configurations can include the communications hardware within the user device 102, such that a wireless network card is unnecessary for communicating wirelessly. Similarly, other embodiments include the network interfaces 398 for communicating via a wired connection. Such interfaces may be configured with Universal Serial Bus (USB) interfaces, serial ports, and/or other interfaces.

If the user device 102 includes a personal computer, workstation, or the like, the software in the memory 384 may further include a basic input output system (BIOS) (omitted for simplicity). The BIOS is a set of software routines that initialize and test hardware at startup, start the operating system 386, and support the transfer of data among the hardware devices. The BIOS is stored in ROM so that the BIOS can be executed when the user device 102 is activated.

When the user device 102 is in operation, the processor 382 may be configured to execute software stored within the memory 384, to communicate data to and from the memory 384, and to generally control operations of the user device 102 pursuant to the software. Software in the memory 384, in whole or in part, may be read by the processor 382, perhaps buffered within the processor 382, and then executed.

One should note that while the description with respect to FIG. 3 includes the user device 102 as a single component, this is a nonlimiting example. More specifically, in at least one embodiment, the user device 102 can include a plurality of servers, personal computers, and/or other devices. Similarly, while the description of FIG. 3 describes the user device 102, this is also a nonlimiting example, as other components may also be included in this description.

Additionally, while the web browser logic 397 and IM logic 399 is illustrated in FIG. 3 as each including a single software component, this is also a nonlimiting example. In at least one embodiment, the web browser logic 397 and/or IM logic 399 may include one or more components, embodied in software, hardware, and/or firmware. As a nonlimiting example, the web browser logic 397 may include one or more modules for executing dynamic web data. The modules may include, but are not limited to a COM module 810 (FIG. 8), an IM module, a sports module, a weather module, an alerts module, a movie module, a chat module, a stocks module, and other modules for providing dynamic data. Additionally, while the web browser 397 and/or IM logic 399 is depicted as residing on a single computing device, such as user device 102, the web browser logic 397 and/or IM logic 399 may include one or more components residing on one or more different devices.

The embodiments disclosed herein can be implemented in hardware, software, firmware, or a combination thereof. At least one embodiment disclosed herein is implemented in software and/or firmware that is stored in a memory and that is executed by a suitable instruction execution system. If implemented in hardware, as in an alternative embodiment, embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 4 is a diagram illustrating an exemplary embodiment of a quick connect interface 408, which may be utilized by a user device, such as the user device 102 from FIG. 1. As illustrated in the nonlimiting example of FIG. 4, the quick connect device interface 408 may be configured to provide presence data 484a-484f associated with a plurality of contacts 482. Depending on the particular configuration, the presence data 484a-484f may include any number of different presence types and statuses. More specifically, the presence data 484a may be configured to provide email presence data. Email presence data may include any number of different statuses including, but not limited to present, not present, busy, etc. Similarly the presence data 484b may be configured to provide Session Initiation Protocol (SIP) presence, for example, on a mobile telephone. The presence data 484c may be configured to provide IM presence. The presence data 484d may be configured to provide photo-sharing presence. The presence data 484e may be configured to provide file-sharing presence. The presence data 484f may be configured to provide Asynchronous Serial Interface (ASI) locator data.

Additionally included in the quick connect device interface 408 is a calendar option 486, an add new contact option 488, a send message option 490, a note pad option 492, and a help option 494. Selection of the calendar option 486 may display a calendar with one or more user configured appointments. Similarly, selection of the add new contact option 488 may open another display (e.g., see FIG. 5) for adding a new contact to the display 408. The send message option 490 may be configured to facilitate message composition, such as for an email message, an Instant Message, a Short Messaging Session (SMS) message, etc. The note pad option 492 may be configured to provide an interface for taking notes and other options. The help option 494 may be configured to provide assistance with the quick connect device interface 408.

One should note that the contacts 482, the calendar appointments (not shown), as well as other data may be stored locally and/or remotely at the web server 104 and/or the data storage 106. Additionally, similar to the web browser display 108, in at least one embodiment, the quick connect device interface 408 may be constrained to a limited number of sockets for at least a portion of the Internet communications. As such, depending on the configuration (and/or the particular application being executed), continuous connections and/or dynamic data may be limited in some situations.

FIG. 5 is a diagram illustrating an exemplary embodiment of an add new contact interface 508, which may be displayed, in response to selection of the add new contact option 488 from FIG. 4. More specifically, as illustrated in the nonlimiting example of FIG. 5, upon selection of the new contact option 488, the user can be provided with one or more fields for entering a new contact. The fields may request any number of different criteria and may be associated with contacting another user. Upon entering data for the new contact, the user can select an add option 582 to store the entered data locally, at the web server 104 and/or, at the data storage 106. By selecting a cancel option 584, the user may return to interface 408.

One should note that similar displays may be presented to the user in response to selection of the calendar option 486, the send message option 490, and/or the note pad option 492. While each of these options may include different criteria and functionality, the data entered by the user may be stored at the web server 104 and/or at the data storage 106.

FIG. 6 is a diagram illustrating an exemplary embodiment of an instant messaging interface 208 that may be configured for facilitating an instant messaging session, similar to the interface 208 illustrated in FIG. 2. As illustrated in the nonlimiting example of FIG. 6, the Instant Messaging interface 208 may include a text area 684 for entering a message. Also included is a contacts area 686 for selecting one or more contacts 688 with whom to begin an Instant Messaging session. The contacts area 686 may include presence data associated with one or more of the contacts 688.

One should note that the contacts 688 may be, depending on the particular embodiment, similar to the contacts 482, from FIG. 4. More specifically, while in some embodiments, these contacts may differ, in at least one exemplary embodiment the contacts 482 may coincide, at least in part with the contacts 688. Similarly, one should also note that, depending on the particular configuration, the presence data 484 may coincide with presence data 690.

Also included are a presence option 692, a new contact option 694, a contacts option 696, and a send option 698. More specifically, the presence option 692 may be configured to provide options for presence information related to the contacts. As a nonlimiting example, the user may be provided with an interface to change presence icons associated with his/her presence status. Additionally, the interface may also be configured to provide options related to the user's contacts' presence. Similarly, the new contact option 694 may be configured to facilitate the creation of a new contact, as described below. The contacts option 696 may be configured to provide options associated with existing contacts. The send option 698 may be configured to send a message that is input in the text area 684.

FIG. 7 is a diagram illustrating an exemplary embodiment of a new contact interface 708, which may be accessed in response to selection of the add new contact option 694 from FIG. 6. More specifically, as illustrated in the nonlimiting example of FIG. 7, in response to selection of the new contact option 694, the user can be presented with one or more fields for entering information associated with a new contact. The information may include a first name, a last name, an IM address, and a telephone number. Upon entering data into one or more of the fields, the user can select an add option 782 to store the contact information locally, at the IM server 204, and/or at the data storage 206. Selecting a cancel option 784 can abort creation of the new contact and return the user to IM interface 608. One should also note that the fields illustrated in FIG. 7 may include one or more of the same fields illustrated in the add new contact interface 508 (FIG. 5).

FIG. 8 is a diagram illustrating an exemplary embodiment of a web browser interface 808 that utilizes a COM module 810 in a network configuration, similar to the network configuration from FIGS. 1 and 2. As illustrated in the nonlimiting example of FIG. 8, the web browser interface 808 may access a portal page of a website. Through the website and one or more visible modules 812, 814, 816, 818, 820, and 822, the web browser interface 808 may be configured to display dynamic data without risk of over-utilizing the sockets allocated to the web browser logic 397. More specifically, the stocks module 812 may be configured to display information related to one or more user-defined stocks. The stock data may be continually updated to continually display current data. Additionally included in the web browser interface display 808 are the sports module 818 and a movies module 814, which may be configured to display current sports and movies, respectively. Additionally included in the interface display 808 are the alerts module 820, an IM module 816, and a chat module 822. The alerts module 820 may be configured to access a calendar associated with the user and display one or more of the scheduled events. The IM module 816 may include one or more of the contacts from the web server 104 and/or IM server 204 and may also include an add new contact option 824, similar to the add new contact options 488 and 696, as discussed below. Additionally, current presence data may also be provided, as described above. The chat window 822 may be configured to facilitate a chat session with one or more of the contacts in the IM window 816.

Additionally in the exemplary embodiment of FIG. 8 is a COM module 810. The COM module 810 may be configured to establish a continuous connection via a portal that is different than the portals allocated with the web browser logic 397. More specifically, in at least one nonlimiting example, the COM module 810 may be configured to establish an Internet portal via a locally stored flash player (not shown), which may be configured to provide a continuous connection with the desired data. As such, the COM module 810 may be configured to continuously provide updated data to the web browser display 808 without actively refreshing the web browser, as discussed above. Data such as presence, alerts, Instant Messaging, etc. may be enabled via the COM module 810, which may provide instantaneous (or near instantaneous) updates of this information. Additionally, through use of the COM module 810, one or more executables may be displayed in the web browser display 808. In at least one embodiment, the COM module 810 is not displayed in the web browser interface 808.

One should note that, in at least one exemplary embodiment, the COM module 810 is configured to utilize a single socket that is different than the sockets allocated to the web browser logic 397 for a plurality of different data. More specifically, one or more of the modules 812-822 may utilize the same socket for providing the desired information.

FIG. 9 is a diagram illustrating an exemplary embodiment of the web browser interface 808 and the COM module 810 in a network configuration, similar to the diagram from FIG. 8. As illustrated in the nonlimiting example of FIG. 9, the web browser interface 808 may be configured to access a limited number of sockets to the network 100 (as represented by components 922, 924). In at least one embodiment the sockets 922, 924 may be standard sockets provided with many web browsers. As discussed above, the limited number of sockets may limit the receipt of dynamic data on the web browser interface 808. However, as also discussed above, embodiments of this disclosure may be configured to utilize the COM module 810 for receiving dynamic data from a different socket 932 and utilizing the dynamic data at one or more other modules that may be displayed in the web browser interface 808.

The COM module 810 may be configured to utilize a locally stored flash player (not shown) to create a continuous connection with a server, such as the IM server 204. Additionally, the COM module 810 may be configured to provide local connectivity to applications in the browser. In at least one embodiment, the COM module 810 may have at least one persisted bidirectional socket to send and/or receive data. By creating a continuous connection to the IM server 204, through the web browser logic 397, the web browser interface 808 may be configured to provide presence information, as well as provide IM capabilities directly from the web browser interface 808.

FIG. 10 is a diagram illustrating an exemplary embodiment of the web browser interface 808 and an add new contact interface 1008 in a network configuration, similar to the diagram from FIG. 9. As illustrated in the nonlimiting example of FIG. 10, the web browser interface 808 may be configured with the add new contacts option 824 for launching an add new contact interface 1008. The add new contact interface 1008 may be launched from the web browser interface 808 and may provide one or more fields for information related to a new contact. Upon inputting the desired information, the data can be sent, via the COM module 810 to the IM server 204 for storage. Additionally, as discussed above with respect to FIGS. 4 and 5, the web server 104 may also maintain one or more contacts. As such, the IM module 816 associated with web browser interface 808 may update at least a portion of the contact list maintained by the web server 104.

Additionally, the Pub-Sub network 110 may also provide a continuous connection to provide sports, news, movies, stocks, and/or other data without the need for manually refreshing the web browser logic 397. More specifically, as discussed above, the Pub-Sub network 110 may be configured to communicate with a flash player (and/or other flash logic) at the user device 102. Because the connection between the flash player and the Pub-Sub network 110 operates independently from sockets dedicated to the web browser logic 397, a continuous connection may not affect web browsing.

FIG. 11 is a flowchart illustrating an exemplary embodiment of a process for utilizing a socket that is different than the socket allocated for a web browser, such as the web browser interface 108 from FIG. 1. As illustrated in the nonlimiting example of FIG. 11, the user device 102 may receive a request for a web page (block 1132). The user device 102 may then instantiate the browser logic 397 with the associated COM module 810 (block 1134). The browser logic 397 and the COM module 810 may then determine the visible modules to display (block 1136). The COM module 810 can receive continuous data from updating the visible modules via a flash and/or other socket that is different than the sockets allocated for the web browser logic 397 (block 1138).

FIG. 12 is a flowchart illustrating an exemplary embodiment of a process for facilitating display of presence data in a web page displayed by a web browser interface, such as the web browser interface 808, similar to the flowchart from FIG. 11. As illustrated in the nonlimiting example of FIG. 12, the user device 102 can receive a request for a web page (block 1232). The user device 102 can instantiate the browser logic 397 with the associated COM module 810 (block 1234). The browser logic 397 and COM module 810 can then determine visible modules to display (block 1236). The COM module 810 can facilitate instantiation of an IM module, such as the IM module 816, which can request presence data associated with one or more contacts. The COM module 810 can facilitate a continuous query of one or more Instant Messaging presence servers for presence data associated with one or more contacts of the user (block 1238). By facilitating a continuous query of the IM server 104 (or presence server, which may or may not be included in the IM server 104), the COM module 810 can facilitate the display of current information in the web browser interface 808. The COM module 810 can facilitate display of the presence data in the web browser interface 808 being displayed by the browser (block 1240).

FIG. 13 is a flowchart illustrating an exemplary embodiment of a process that may be utilized for updating a quick connect server, similar to the flowchart from FIG. 12. As illustrated in the nonlimiting example of FIG. 13, the user device 102 can receive a request for a web page (block 1332). The user device 102 can instantiate the browser logic 397, which may be associated with the COM module 810 (block 1334). The browser logic 397 and COM module 810 may be configured to determine visible modules to display (block 1336). An Instant Messaging module, such as the IM module 816, can receive a request to add and/or change a contact (block 1338). The Instant Messaging module 816 can then send the received changes to the COM module 810 (block 1340). The COM module 810 can then update the IM server 204. The COM module 810 can also format the received updates and update the contact list on the web server 104. The COM module 810 can send the formatted updates to the web server 204 (block 1342).

The embodiments disclosed herein can be implemented in hardware, software, firmware, or a combination thereof. At least one embodiment, disclosed herein is implemented in software and/or firmware that is stored in a memory and that is executed by a suitable instruction execution system. If implemented in hardware, as in an alternative embodiment embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for providing data, comprising:
receiving a request at a web browser, the web browser being configured to send data via a first socket;
sending the request to a COM module, the COM module being configured to send data via a second socket, the second socket being different than the first socket;
receiving at least a portion of requested data via the second socket, such that a continuous connection is established via the second socket; and
providing for display, at the web browser, at least a portion of the received data.

2. The method of claim 1, wherein the request is sent from a visible module, the visible module being configured to facilitate display of data on the web browser.

3. The method of claim 2, wherein the visible module includes at least one of the following: a sports module, a stocks module, a weather module, a movies module, an alerts module, an Instant Messaging module, and a chat module.

4. The method of claim 1, wherein the request includes a request to add a contact.

5. The method of claim 4, further comprising:
receiving data related to at least one new contact;
updating a contact list at a first server;
formatting at least a portion of the data related to the at least one new contact; and
updating a second server with the formatted data.

6. The method of claim 1, wherein the visible module includes an Instant Messaging module and wherein the Instant Messaging module is configured to determine presence of at least one contact via the COM module utilizing the second socket.

7. The method of claim 1, wherein the visible module includes an alerts module and wherein the alerts module is configured to access a remotely stored calendar via the COM module utilizing the second socket.

8. A computer readable medium for providing data, comprising:
first receiving logic configured to receive a request at a web browser, the web browser being configured to receive data via a first socket;
COM module logic configured to send data via a second socket, the second socket being different than the first socket;
sending logic configured to send the received request to the COM module logic;
second receiving logic configured to receive at least a portion of requested data via the second socket, such that a continuous connection is established via the second socket; and
providing logic configured to provide, for display at the web browser, at least a portion of the received data.

9. The computer readable medium of claim 8, wherein the request is sent from visible module logic, the visible module logic being configured to facilitate display of data on the web browser.

10. The computer readable medium of claim 9, wherein the visible module logic includes at least one of the following: sports module logic, stocks module logic, weather module logic, movies module logic, alerts module logic, Instant Messaging module logic, and chat module logic.

11. The computer readable medium of claim 8, wherein the request includes a request to add a contact.

12. The computer readable medium of claim 11, further comprising:
third receiving logic configured to receive data related to at least one new contact;
first updating logic configured to update a contact list at a first server;
formatting logic configured to format at least a portion of the data related to the at least one new contact; and
second updating logic configured to update a second server with the formatted data.

13. The computer readable medium of claim 8, wherein the visible module logic includes Instant Messaging module logic and wherein the Instant Messaging module logic is configured to determine presence of at least one contact via the COM module logic utilizing the second socket.

14. The computer readable medium of claim 8, wherein the visible module logic includes alerts module logic and wherein the alerts module logic is configured to access a remotely stored calendar via the COM module logic utilizing the second socket.

15. A user device for providing data, comprising:
a first receiving component configured to receive a request at a web browser, the web browser being configured to receive data via a first socket;
a COM module component configured to send data via a second socket, the second socket being different than the first socket;
a sending component configured to send the received request to the COM module component;
a second receiving component configured to receive at least a portion of requested data via the second socket, such that a continuous connection is established via the second socket; and
a providing component configured to provide, for display at the web browser, at least a portion of the received data.

16. The user device of claim 15, wherein the request is sent from a visible module component, the visible module component being configured to facilitate display of data on the web browser.

17. The user device of claim 16, wherein the visible module component includes at least one of the following: a sports module component, a stocks module component, a weather module component, a movies module component, an alerts module component, an Instant Messaging module component, and a chat module component.

18. The user device of claim 15, wherein the request includes a request to add a contact.

19. The user device of claim 18, further comprising:
a third receiving component configured to receive data related to at least one new contact;
a first updating component configured to update a contact list at a first server;
a formatting component configured to format at least a portion of the data related to the at least one new contact; and
a second updating component configured to update a second server with the formatted data.

20. The user device of claim 15, wherein the visible module component includes an Instant Messaging module component and wherein the Instant Messaging module component is configured to determine presence of at least one contact via the COM module component utilizing the second socket.
